(19) United States
(12) Patent Application Publication
(10) Pub. No.: US 2026/0175744 A1
(43) Pub. Date: Jun. 25, 2026

(54) VEHICLE DRIVING POSTURE ADJUSTING DEVICE

(71) Applicant: TOYOTA JIDOSHA KABUSHIKI KAISHA, Toyota-shi (JP)

(72) Inventors: Hideyuki SAKURAI, Toyota-shi (JP); Katsuya Shimazu, Toyota-shi (JP); Mutsumi Kawashima, Nisshin-shi (JP); Shingo Fujimoto, Toyota-shi (JP)

(73) Assignee: TOYOTA JIDOSHA KABUSHIKI KAISHA, Toyota-shi (JP)

(21) Appl. No.: 19/386,299

(22) Filed: Nov. 12, 2025

(30) Foreign Application Priority Data
Dec. 25, 2024 (JP) 2024-228264

(51) Int. Cl. B60N 2/00; B60N 2/02; B60N 2/64

(52) U.S. Cl. CPC B60N 2/0028; B60N 2/0226; B60N 2/0284; B60N 2/64

(57) ABSTRACT

The vehicle driving posture adjusting device includes a seat cushion having a cushion length varying mechanism that allows the length in the seat front-rear direction to be changed, a cushion load detection device that is provided in the seat cushion and detects a cushion load acting on the seat cushion by the seated occupant, and a foot placement detection device that detects that the foot of the seated occupant is placed on the accelerator pedal. The adjustment device adjusts the length of the seat cushion in the seat front-rear direction by the cushion length varying mechanism so that the cushion load does not exceed a predetermined threshold value by using foot rest detection information on the accelerator pedal by the foot placement detection device as a trigger during the driving posture adjustment.

### CROSS-REFERENCE TO RELATED APPLICATION

This application claims priority to Japanese Patent Application No. 2024-228264 filed on December 25, 2024. The disclosure of the above-identified application, including the specification, drawings, and claims, is incorporated by reference herein in its entirety.

### BACKGROUND

### 1. Technical Field

The present disclosure relates to a vehicle driving posture adjusting device.

### 2. Description of Related Art

A sheet adjustment device capable of adjusting the up-down height and the front-rear length of a seat cushion is conventionally known (see Japanese Unexamined Utility Model Application Publication No. 05-065657, for example). With the seat adjustment device, even a short occupant does not have his/her calves in contact with the front end portion of the seat cushion.

### SUMMARY

However, in the case of a short occupant, his/her waist may not reach a seat back when his/her foot is placed on an accelerator pedal without having the calves in contact with the front end portion of the seat cushion. In this state, even if the occupant throws his/her back on the seat back, the back surface of the waist does not come into close contact with the seat back, and therefore his/her pelvis tilts backward.

As a result, the amount of support for the upper body of the occupant by the seat back is reduced, and therefore the upper body becomes unstable against lateral swings. In addition, when the occupant attempts to place the foot on the accelerator pedal, there is a possibility that the heel does not reach the floor (the foot may not be normally placed on the accelerator pedal), and there is a possibility that a delicate operation to depress the accelerator pedal may not be performed.

Accordingly, an object of the present disclosure is to provide a vehicle driving posture adjusting device that allows even a short occupant to have his/her waist in close contact with a seat back without having his/her calves in contact with the front end portion of a seat cushion, and to normally place his/her foot on an accelerator pedal.

A first aspect of the present disclosure provides a vehicle driving posture adjusting device including:

a seat cushion including a cushion length varying mechanism that is able to change a length of the seat cushion in a seat front-rear direction;

a cushion load detection device provided in the seat cushion and configured to detect a cushion load applied to the seat cushion by a seated occupant; and

a foot placement detection device configured to detect that a foot of the seated occupant is placed on an accelerator pedal, in which

when adjusting a driving posture, the cushion length varying mechanism adjusts the length of the seat cushion in the seat front-rear direction such that the cushion load does not exceed a predetermined threshold value using information on detection of foot placement on the accelerator pedal from the foot placement detection device as a trigger.

According to the first aspect, the seat cushion includes a cushion length varying mechanism capable of changing a length of the seat cushion in the seat front-rear direction. The seat cushion is provided with a cushion load detection device that detects a cushion load applied to the seat cushion by a seated occupant. Further, a foot placement detection device that detects that a foot of the seated occupant is placed on an accelerator pedal is provided.

Here, when adjusting a driving posture, the cushion length varying mechanism adjusts the length of the seat cushion in the seat front-rear direction such that the cushion load does not exceed a predetermined threshold value using information on detection of foot placement on the accelerator pedal from the foot placement detection device as a trigger. Thus, even a short occupant can have his/her waist in close contact with a seat back without having his/her calves in contact with the front end portion of a seat cushion, and normally place his/her foot on an accelerator pedal.

In the first aspect, the vehicle driving posture adjusting device may further include

a back load detection device provided in a seat back and configured to detect a back load applied to the seat back by the seated occupant, and

when the vehicle driving posture adjusting device adjusts the driving posture, the cushion length varying mechanism may adjust the length of the seat cushion in the seat front-rear direction such that the back load does not become less than a predetermined threshold value.

According to the above configuration, the seat back is provided with a back load detection device that detects a back load applied to the seat back by the seated occupant. When adjusting the driving posture, the cushion length varying mechanism adjusts the length of the seat cushion in the seat front-rear direction such that the back load does not become less than a predetermined threshold value. Thus, even a short occupant can reliably have his/her waist in close contact with a seat back without having his/her calves in contact with the front end portion of a seat cushion, and normally place his/her foot on an accelerator pedal.

A second aspect of the present disclosure provides a vehicle driving posture adjusting device including:

a seat cushion having a cushion length varying mechanism that is able to change a length of the seat cushion in a seat front-rear direction and a seat surface angle varying mechanism that is able to change a seat surface angle;

a cushion load detection device provided in the seat cushion and configured to detect a cushion load applied to the seat cushion by a seated occupant;

a back load detection device provided in a seat back and configured to detect a back load applied to the seat back by the seated occupant; and

a foot placement detection device configured to detect that a foot of the seated occupant is placed on an accelerator pedal, in which

when adjusting a driving posture, the cushion length varying mechanism adjusts the length of the seat cushion in the seat front-rear direction and the seat surface angle varying mechanism adjusts the seat surface angle of the seat cushion such that the cushion load does not exceed a predetermined threshold value and the back load does not become less than a predetermined threshold value using information on detection of foot placement on the accelerator pedal from the foot placement detection device as a trigger.

According to the second aspect, the seat cushion includes a cushion length varying mechanism capable of changing a length of the seat cushion in a seat front-rear direction and a seat surface angle varying mechanism capable of changing a seat surface angle; The seat cushion is provided with a cushion load detection device that detects a cushion load applied to the seat cushion by a seated occupant. Further, the seat back is provided with a back load detection device that detects a back load applied to the seat back by the seated occupant. Further, a foot placement detection device that detects that a foot of the seated occupant is placed on an accelerator pedal is provided.

Here, when adjusting a driving posture, the cushion length varying mechanism adjusts the length of the seat cushion in the seat front-rear direction and the seat surface angle varying mechanism adjusts the seat surface angle of the seat cushion such that the cushion load does not exceed a predetermined threshold value and the back load does not become less than a predetermined threshold value using information on detection of foot placement on the accelerator pedal from the foot placement detection device as a trigger. Thus, even a short occupant can reliably have his/her waist in close contact with a seat back without having his/her calves in contact with the front end portion of a seat cushion, and normally place his/her foot on an accelerator pedal.

In the vehicle driving posture adjusting device according to the above aspect,

among a cushion front end sensor that detects a cushion load acting on a front end surface of the seat cushion and a cushion upper surface sensor that detects a cushion load acting on a seat surface front portion of the seat cushion, the cushion load detection device may include at least the cushion front end sensor; and

the foot placement detection device may include any of a pedal operation amount sensor, a pressure sensor provided on an upper surface of the accelerator pedal, and a foot camera.

According to the above configuration, among a cushion front end sensor that detects a cushion load acting on a front end surface of the seat cushion and a cushion upper surface sensor that detects a cushion load acting on a seat surface front portion of the seat cushion, the cushion load detection device includes at least the cushion front end sensor. The foot placement detection device includes any of a pedal operation amount sensor, a pressure sensor provided on an upper surface of the accelerator pedal, and a foot camera. Thus, the cushion load and the foot placement detection information are accurately detected.

In the vehicle driving posture adjusting device according to the above aspect,

the cushion load detection device may include a cushion front-end upper portion sensor that detects a cushion load acting on a front-end upper portion of the seat cushion; and

the foot placement detection device may include any of a pedal operation amount sensor, a pressure sensor provided on an upper surface of the accelerator pedal, and a foot camera.

According to the above configuration, the cushion load detection device may include a cushion front-end upper portion sensor that detects a cushion load acting on a front-end upper portion of the seat cushion. The foot placement detection device includes any of a pedal operation amount sensor, a pressure sensor provided on an upper surface of the accelerator pedal, and a foot camera. Thus, the cushion load and the foot placement detection information are accurately detected.

As described above, according to the present disclosure, even a short occupant can have his/her waist in close contact with a seat back without having his/her calves in contact with the front end portion of a seat cushion, and normally place his/her foot on an accelerator pedal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view showing a state before the seat cushion length according to the first embodiment is adjusted at the top, and a state after the center of the middle adjusts the seat cushion length according to the first embodiment, and a state before the bottom adjusts the seat cushion length according to the first embodiment;

FIG. 2A is a schematic perspective view illustrating a rod retracted state of a cushion length varying mechanism according to a first embodiment;

FIG. 2B is a schematic perspective view illustrating a rod projected state of a cushion length varying mechanism according to a first embodiment;

FIG. 3 is a flowchart illustrating an operation of the vehicle driving posture adjusting device according to the first embodiment;

FIG. 4 is a schematic side view showing a state before the seat cushion length and the seat angle according to the second embodiment are adjusted at the top, and a state after the center of the middle adjusts the seat cushion length and the seat angle according to the second embodiment, and a state before the bottom adjusts the seat cushion length and the seat angle according to the first embodiment;

FIG. 5 is a flowchart showing the operation of the vehicle driving posture adjusting device according to the second embodiment; and

FIG. 6 is a schematic side view illustrating a modified example of the cushion load detection device according to the second embodiment in a partially enlarged manner.

### DETAILED DESCRIPTION OF EMBODIMENTS

Hereinafter, embodiments according to the present disclosure will be described in detail with reference to the drawings. For convenience of description, the arrow UP, the arrow FR, and the arrow RH appropriately shown in the figures indicate the upward direction of a seat, the forward direction of the seat, and the right direction of the seat, respectively. Thus, when terms indicating directions, i.e., upward and downward, forward and rearward, and right and left are used in the following description without any specification, these mean upward and downward of the vehicle seat, forward and rearward of the vehicle seat, and right and left of the vehicle seat. Further, the right-left direction is synonymous with a seat width direction.

### First Embodiment

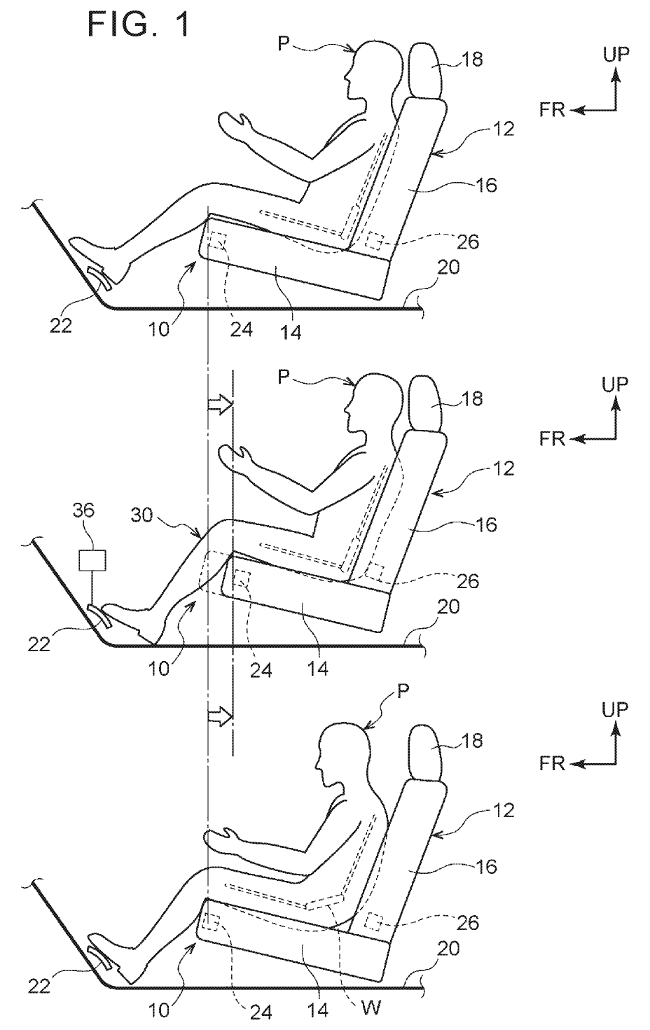

First, a first embodiment will be described. As shown in FIG. 1, the vehicle seat 12 including the vehicle driving posture adjusting device 10 according to the first embodiment includes a seat cushion 14, a seat back 16, and a headrest 18. The seat back 16 is provided at a rear end portion of the seat cushion 14 so as to be rotatable (tiltable backward and tiltable forward) in the left-right direction as an axial direction. The headrest 18 is provided so as to be movable up and down in a central portion in the seat width direction at an upper end portion of the seat back 16.

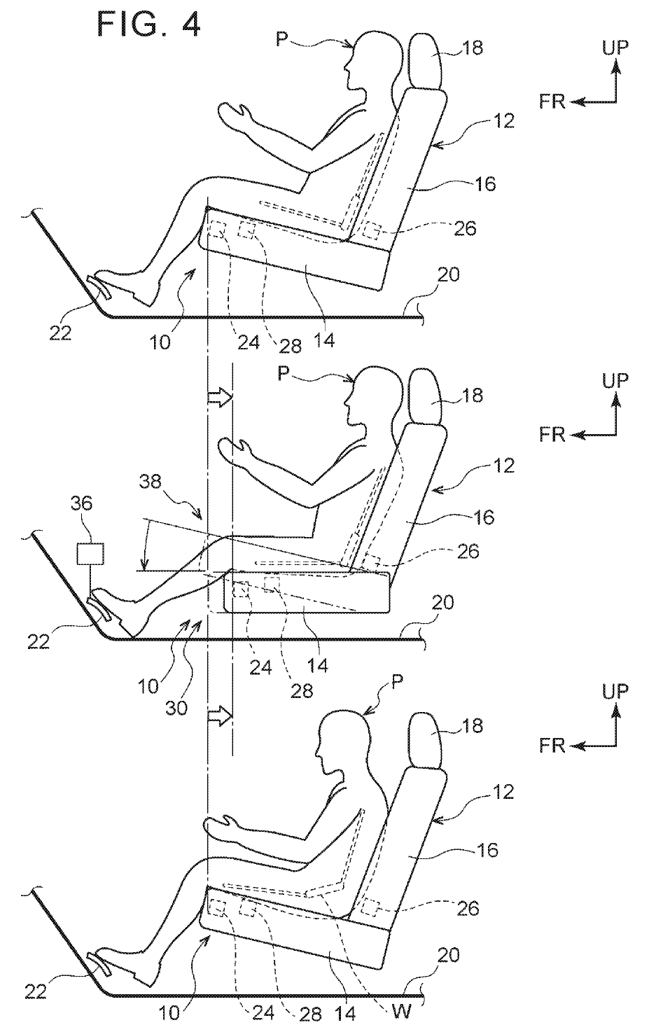

FIG. 1 and FIG. 4, which will be described later, show a state in which a dummy doll (human body dummy) as a model of an occupant is seated on the seat cushion 14 of the vehicle seat 12. The dummy doll is, for example, a AF05 (5th percentile of American adult women) corresponding to a small occupant. Hereinafter, the dummy doll of AF05 is referred to as an "occupant P". The occupant (seated occupant) P is restrained by the vehicle seat 12 by a three-point seat belt device, but the seat belt device is not illustrated in FIGS. 1 and 4.

As shown in FIG. 1, the vehicle seat 12 is provided on the floor 20 of the vehicle cabin, and an accelerator pedal 22 is disposed on the front side of the floor 20. In addition, a cushion front end sensor (sometimes referred to as a "cushion sensor" or a "CF sensor") 24 as a cushion load detection device is provided inside a front end portion of the seat cushion 14 in the vehicle seat 12. A seat back sensor (sometimes referred to as a "SB sensor") 26 as a back load detection device is provided inside a lower portion of the seat back 16 (a portion mainly opposed to the waist portion).

The cushion front end sensor 24 detects a cushion load acting on the front end face of the seat cushion 14 by the occupant P, specifically, a cushion load caused by interference of calves of the occupant P (hitting at a predetermined pressure). The seat back sensor 26 detects a back load acting on the lower portion of the seat back 16 by the occupant P, specifically, a back load caused by contact (close contact) of the back portion (mainly the waist portion) of the occupant P.

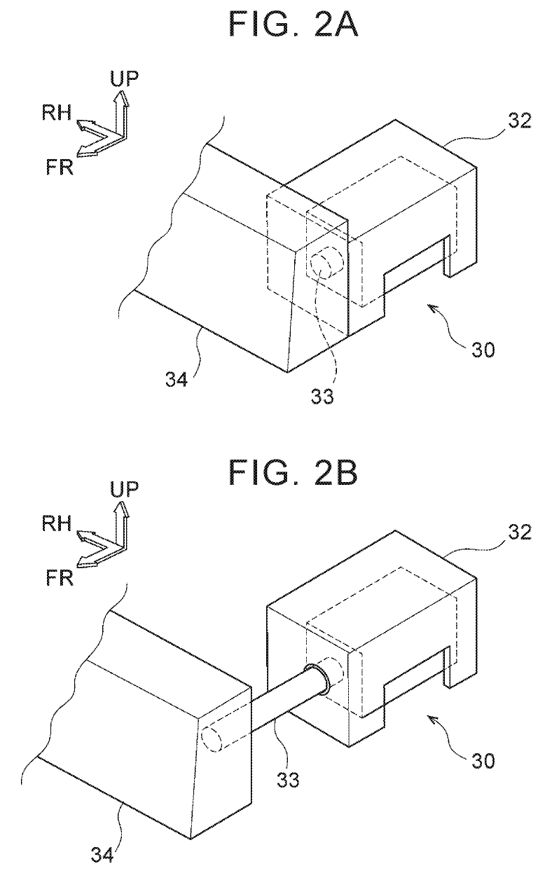

Further, the seat cushion 14 is provided with a known cushion length varying mechanism 30. As shown in FIGS. 2A and 2B, the cushion length varying mechanism 30 includes a pair of left and right actuators 32 disposed in both left and right end portions of the front portion of the seat cushion 14. Each of the actuators 32 has a cylindrical rod 33 having a predetermined length that projects toward the front side or is stored toward the rear side in synchronization with the driving of a driving source (not shown).

Between the front end portions of the pair of right and left rods 33, a front frame 34 extending in the seat width direction and constituting the front end portion of the seat cushion frame is installed. The front frame 34 (the front end portion of the seat cushion 14) is configured to move forward when each rod 33 protrudes from the inside of the actuator 32, thereby increasing the length of the seat cushion 14 in the front-rear direction.

Conversely, the front frame 34 (the front end portion of the seat cushion 14) is configured such that each rod 33 is retracted by being retracted into the actuator 32 to shorten the length of the seat cushion 14 in the front-rear direction. That is, the length of the seat cushion 14 in the front-rear direction can be changed (adjusted) by the cushion length varying mechanism 30.

In addition, a known foot placement detection device 36 (refer to the middle view in FIG. 1) for detecting that the foot of the occupant P is placed on the accelerator pedal 22 is provided in the vehicle cabin (vehicle). The foot placement detection device 36 includes, for example, any one of a pedal opening degree sensor, a pressure sensor provided on an upper surface of the accelerator pedal 22, and a foot camera. In addition, the cushion front end sensor 24, the seat back sensor 26, and the foot placement detection device 36 are electrically connected to a control device (not shown) provided in the vehicle, and the cushion length varying mechanism 30 is configured to be controlled by the control device.

Next, the operation (method of adjusting the driving posture) of the vehicle driving posture adjusting device 10 according to the first embodiment configured as described above will be described.

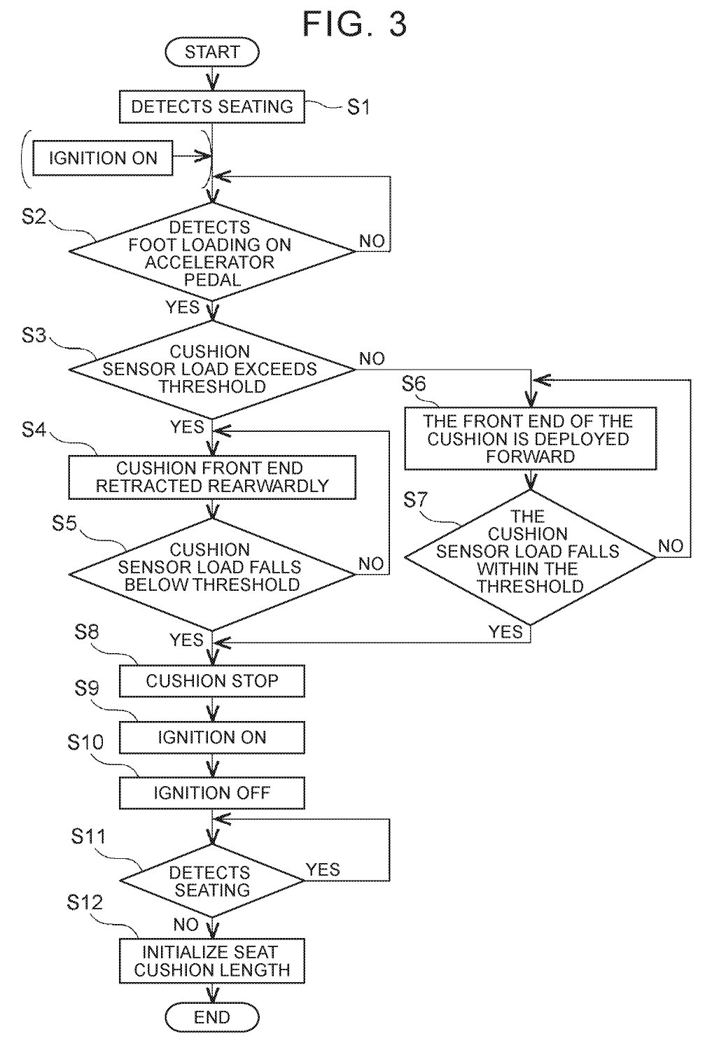

As shown in FIG. 3, when adjusting the driving attitude, first, it is detected that the occupant P is seated on the seat cushion 14 of the vehicle seat 12 (S1). Next, the foot placement detection device 36 (any of the pedal opening sensor, the pressure sensor provided on the upper surface of the accelerator pedal 22, and the foot camera) detects that the foot of the occupant P is placed on the accelerator pedal 22 (S2). When the foot placement detection device 36 does not detect that the foot of the occupant P is placed on the accelerator pedal 22, S2 is returned.

When the foot placement detection device 36 detects that the foot of the occupant P is placed on the accelerator pedal 22, the cushion front end sensor (cushion sensor) 24 determines whether or not the cushion load exceeds a predetermined threshold (S3). As used herein, the term "threshold" refers to a predetermined numerical range including a minimum value and a maximum value. Thus, "above threshold" means above its maximum value. The term "less than the threshold value" means less than the minimum value. In addition, "within the threshold value" means a range from the minimum value to the maximum value.

When the cushion load exceeds the predetermined threshold value, the front end portion (front frame 34) of the seat cushion 14 is moved slightly backward by the cushion length varying mechanism 30 (retracted backward by a predetermined amount). Accordingly, the length of the seat cushion 14 is shortened (S4). The cushion front end sensor 24 then determines whether the cushion load is below a predetermined threshold (S5). When the cushioning load does not fall below the predetermined thresholds, S4 is returned.

On the other hand, in S3, when it is determined that the cushion load does not exceed the predetermined threshold value, the front end portion (front frame 34) of the seat cushion 14 is moved forward by a small amount (expanded forward by a predetermined amount) by the cushion length varying mechanism 30. Accordingly, the length of the seat cushion 14 is increased (S6). The cushion front end sensor 24 then determines whether the cushion load is within a predetermined threshold (S7). When the cushioning load does not fall within the predetermined thresholds, S6 is returned.

When the cushion load falls below a predetermined threshold value or falls within a predetermined threshold value, that is, when the cushion load does not exceed the predetermined threshold value, the cushion length varying mechanism 30 is S8. This completes the adjustment of the driving posture of the occupant P seated on the vehicle seat 12.

After S2 and prior to S3, the seat back sensor 26 may determine whether the back load is less than a predetermined threshold. When the back load is not less than the predetermined thresholds, the process may be shifted to S3. In addition, when it is determined that the back load is less than the predetermined threshold value, it is possible to determine that the pelvis W (see the bottom view in FIG. 1) is tilted backward (the waist portion of the occupant P is not in close contact with the seat back 16), and thus the process may be shifted to S4 (or S3).

As described above, at the time of adjusting the driving posture, the length of the seat cushion 14 in the front-rear direction is adjusted by the cushion length varying mechanism 30 so that the cushion load does not exceed the predetermined threshold value and the back load does not become less than the predetermined threshold value using the foot rest detection information on the accelerator pedal 22 by the foot placement detection device 36 as a trigger.

That is, by adjusting the length of the seat cushion 14 in the front-rear direction, even a short occupant P can make the waist of the seat cushion 14 in close contact with the seat back 16 without bringing the calf into contact with the front end of the seat cushion. Accordingly, the amount of support of the seat back 16 with respect to the upper body of the occupant P can be secured, and the upper body can be stabilized with respect to the left and right swings during the traveling of the vehicle. Since the pelvis W is arranged substantially parallel to the seat back 16 in a side view, the restraint by the seat belt device is improved.

In addition, the occupant P can bend his/her knee as intended in a state in which the waist portion is brought into close contact with the seat back 16, so that the occupant P can normally place his/her foot on the accelerator pedal 22. That is, the occupant P can place the heel on the floor 20 when placing the foot on the accelerator pedal 22. As a result, the occupant P can perform a delicate depression operation on the accelerator pedal 22, so that the driving operability can be improved.

When the driving attitude is adjusted in this way, the ignition may be turned S9 and the vehicle may be started. Note that the timing of turning on the ignition may be after S1 and prior to S2.

When the driving of the vehicles is finished, the ignition is turned off (S10). Next, it is determined whether or not the occupant P is still seated on the seat cushion 14 of the vehicle seat 12 (S11). When the occupant P remains seated, S11 is returned.

When the occupant P descends from the seat cushion 14 of the vehicle seat 12, the cushion length varying mechanism 30 operates to return (initialize: S12) the cushion length of the seat cushion 14 to the initial position. Accordingly, when another occupant drives the vehicle next time, the driving posture is easily adjusted so as to conform to the physique of the occupant.

It should be noted that not only the cushion front end sensor (cushion sensor) 24 that detects the cushion load acting on the front end surface of the seat cushion 14. As in the second embodiment described later, a cushion upper surface sensor 28 (see FIG. 4) for detecting a cushion load acting on the front portion of the seat surface of the seat cushion 14 may be provided in the seat cushion 14. In this case, in the flowchart shown in FIG. 3, the "cushion sensor" is the "cushion sensor and the cushion upper surface sensor".

The cushion load detection device may include at least the cushion front end sensor 24 among the cushion front end sensor 24 and the cushion upper surface sensor 28. The foot placement detection device 36 may include any of a pedal opening degree sensor, a pressure sensor provided on an upper surface of the accelerator pedal 22, and a foot camera. With such a configuration, it is possible to accurately detect the cushion load and the foot rest detection information.

### Second Embodiment

Next, a second embodiment will be described. The same parts as those in the first embodiment are designated by the same reference signs, and detailed description thereof will be omitted as appropriate.

As shown in FIG. 4, not only the cushion front end sensor (CF sensor) 24 is provided in the seat cushion 14 in the second embodiment. A cushion upper surface sensor 28 as a cushion load detection device for detecting a cushion load acting on the seat front portion of the seat cushion 14 is also provided. The cushion upper surface sensor 28 is also electrically connected to the controller.

In addition, in the second embodiment, the height position of the seat cushion 14 is higher than the height position of the seat cushion 14 in the first embodiment. Therefore, the seat cushion 14 in the second embodiment is provided not only with the cushion length varying mechanism 30, but also with a known seat surface angle varying mechanism 38 (see the middle view in FIG. 4) that allows the seat surface angle of the seat cushion 14 to be changed. The seat surface angle varying mechanism 38 is also configured to be controlled by the control device.

Next, the operation (method of adjusting the driving posture) of the vehicle driving posture adjusting device 10 according to the second embodiment configured as described above will be described. The description of the operation common to the first embodiment will be omitted as appropriate.

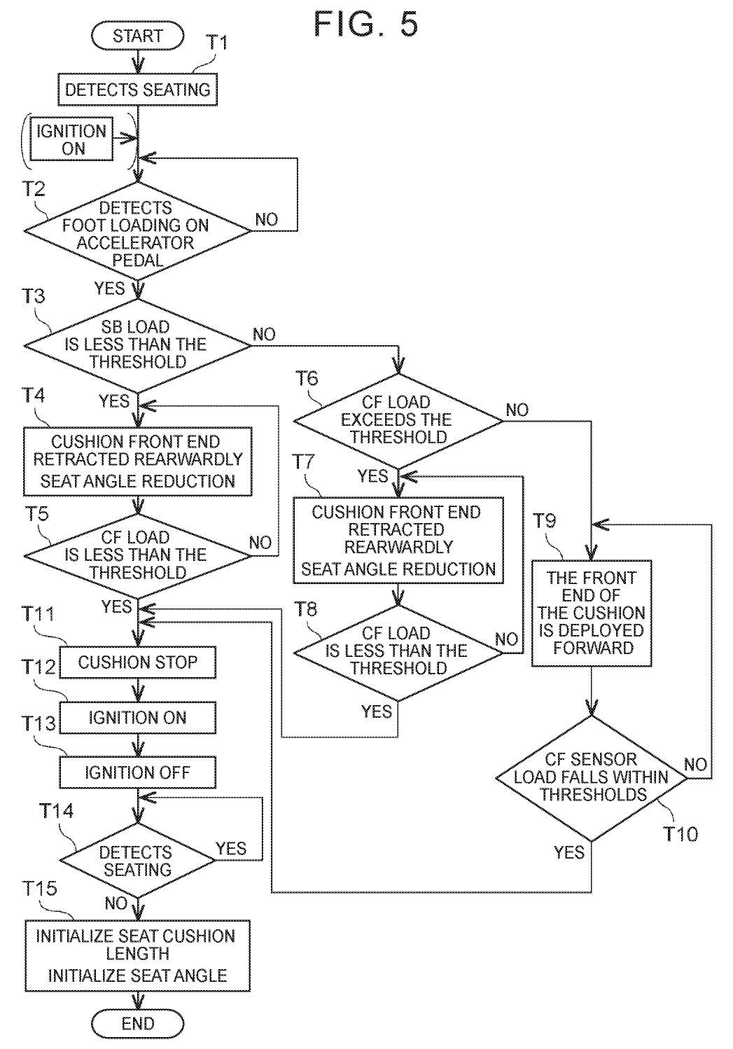

As shown in FIG. 5, when adjusting the driving attitude, first, it is detected that the occupant P is seated on the seat cushion 14 of the vehicle seat 12 (step T1). Next, the foot placement detection device 36 (a pedal opening sensor, a pressure sensor provided on the upper surface of the accelerator pedal 22, or a foot camera) detects that the foot of the occupant P is placed on the accelerator pedal 22 (step T2). When it is not detected by the foot placement detection device 36 that the foot of the occupant P is placed on the accelerator pedal 22, the process returns to T2 of steps.

When the foot placement detection device 36 detects that the foot of the occupant P is placed on the accelerator pedal 22, the seat back sensor (SB sensor) 26 determines whether or not the back load is less than a predetermined threshold (step T3). When it is determined that the back load is less than the predetermined threshold value, it can be determined that the pelvis W (see the bottom view in FIG. 4) is tilted backward (the waist portion of the occupant P is not in close contact with the seat back 16).

Therefore, the front end portion (front frame 34) of the seat cushion 14 is moved slightly backward (stored backward by a predetermined amount) by the cushion length varying mechanism 30, and the length of the seat cushion 14 is shortened. Then, the seat surface angle of the seat cushion 14 is reduced by a small amount (by a predetermined amount) by the seat surface angle varying mechanism 38 (step T4). Next, the cushion front end sensor (CF sensor) 24 determines whether the cushion load is less than a predetermined threshold (step T5). When the cushioning load does not fall below a predetermined threshold, the process returns to T4 of steps.

On the other hand, in the step T3, when it is determined that the back load is not less than the predetermined threshold value, the cushion front end sensor (CF sensor) 24 determines whether or not the cushion load exceeds the predetermined threshold value (step T6).

When the cushion load exceeds the predetermined threshold value, the front end portion (front frame 34) of the seat cushion 14 is moved slightly backward (stored backward by a predetermined amount) by the cushion length varying mechanism 30, and the length of the seat cushion 14 is shortened. Then, the seat surface angle of the seat cushion 14 is reduced by a small amount (by a predetermined amount) by the seat surface angle varying mechanism 38 (step T7). Next, the cushion front end sensor (CF sensor) 24 determines whether the cushion load is less than a predetermined threshold (step T8). When the cushioning load does not fall below a predetermined threshold, the process returns to T7 of steps.

Further, in the step T6, when it is determined that the cushion load does not exceed the predetermined threshold value, the front end portion (front frame 34) of the seat cushion 14 is slightly moved forward (expanded forward by a predetermined amount) by the cushion length varying mechanism 30. Accordingly, the length of the seat cushion 14 is increased (step T9). Next, the cushion front end sensor (CF sensor) 24 determines whether or not the cushion load falls within a predetermined threshold (step T10). When the cushioning load is not within the predetermined thresholds, the process returns to T9 of steps.

When the cushion load falls below the predetermined threshold value or falls within the predetermined threshold value, that is, when the cushion load does not exceed the predetermined threshold value, the operation of the cushion length varying mechanism 30 and the operation of the seat surface angle varying mechanism 38 are stopped (step T11). This completes the adjustment of the driving posture of the occupant P seated on the vehicle seat 12.

As described above, when the driving posture is adjusted, the length of the seat cushion 14 in the front-rear direction is adjusted by the cushion length varying mechanism 30 and the seat surface angle of the seat cushion 14 is adjusted by the seat surface angle varying mechanism 38 so that the cushion load does not exceed the predetermined threshold value and the back load does not become less than the predetermined threshold value using the foot rest detection information on the accelerator pedal 22 by the foot placement detection device 36 as a trigger.

Therefore, compared to the first embodiment, the waist portion of the occupant P can be more reliably brought into close contact with the seat back 16. That is, even a short occupant P can reliably bring the waist portion into close contact with the seat back 16 without bringing the calf into contact with the front end portion of the seat cushion 14, and can normally put the foot on the accelerator pedal 22.

When the driving attitude is adjusted in this way, the ignition may be turned on (step T12) and the vehicle may be started. Note that the timing of turning on the ignition may be after the step T1 and prior to the step T2.

When the driving of the vehicles is completed, the ignition is turned off (T13 in steps). Next, it is determined whether or not the occupant P is still seated on the seat cushion 14 of the vehicle seat 12 (step T14). When the occupant P remains seated, the process returns to T14 of steps.

When the occupant P descends from the seat cushion 14 of the vehicle seat 12, the cushion length varying mechanism 30 and the seat surface angle varying mechanism 38 are operated to return (initialize: step T15) the cushion length and the seat surface angle of the seat cushion 14 to the initial position. Accordingly, when another occupant drives the vehicle next time, the driving posture is easily adjusted so as to conform to the physique of the occupant.

It should be noted that not only the cushion front end sensor (CF sensor) 24 that detects the cushion load acting on the front end surface of the seat cushion 14. When the cushion upper surface sensor 28 that detects the cushion load acting on the seat front portion of the seat cushion 14 also detects the cushion load, the "CF sensor" is the "CF sensor and the cushion upper surface sensor" in the flowchart shown in FIG. 5.

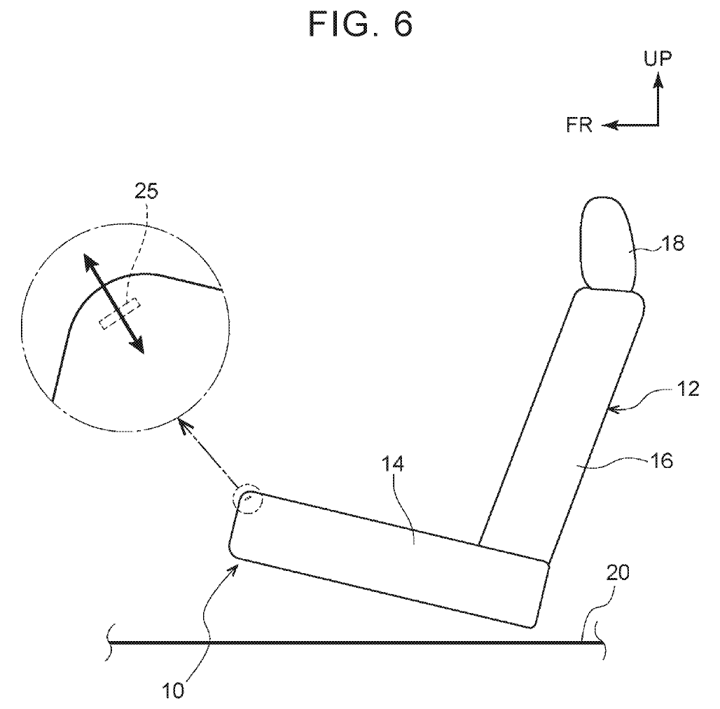

Further, as shown in FIG. 6, as long as the front end upper portion of the seat cushion 14 has a gentle curved shape in a side view and the load caused by the interference of the calf of the occupant P can be appropriately detected, only the cushion front end upper sensor 25 that detects the cushion load acting on the front end upper portion of the seat cushion 14 may be provided in the seat cushion 14 instead of the cushion front end sensor 24 and the cushion upper surface sensor 28.

In addition, at least one of the cushion front end sensor 24 and the cushion upper surface sensor 28 may also be used as an occupant seating sensor, or the cushion front end upper sensor 25 may also be used as an occupant seating sensor. According to this, it is possible to suppress an increase in manufacturing cost in the vehicle seat 12.

The vehicle driving posture adjusting device 10 according to the present embodiment has been described above with reference to the drawings. However, the vehicle driving posture adjusting device 10 according to the present embodiment is not limited to the illustrated one, and can be appropriately changed in design without departing from the gist of the present disclosure. For example, in the second embodiment, the reduction of the seat surface angle of the seat cushion 14 may be performed only when it is determined that the seat surface angle is necessary based on the foot rest detection information, the back load, and the cushion load on the accelerator pedal 22 by the foot placement detection device 36.

Further, instead of using the foot rest detection information on the accelerator pedal 22 by the foot placement detection device 36 as a trigger, the adjustment of the driving posture may be started by using the recognition of the seated occupant by a camera (not shown) in the vehicle cabin and the voice instruction of the occupant as a trigger. Further, the back load detection device and the cushion load detection device are not limited to the pressure sensors such as the seat back sensor 26 and the cushion front end sensor 24, respectively.

What is claimed is:

1. A vehicle driving posture adjusting device comprising:
a seat cushion including a cushion length varying mechanism that is able to change a length of the seat cushion in a seat front-rear direction;
a cushion load detection device provided in the seat cushion and configured to detect a cushion load applied to the seat cushion by a seated occupant; and
a foot placement detection device configured to detect that a foot of the seated occupant is placed on an accelerator pedal, wherein
when adjusting a driving posture, the cushion length varying mechanism adjusts the length of the seat cushion in the seat front-rear direction such that the cushion load does not exceed a predetermined threshold value using information on detection of foot placement on the accelerator pedal from the foot placement detection device as a trigger.

2. The vehicle driving posture adjusting device according to claim 1, further comprising a back load detection device provided in a seat back and configured to detect a back load applied to the seat back by the seated occupant, wherein
when adjusting the driving posture, the cushion length varying mechanism adjusts the length of the seat cushion in the seat front-rear direction such that the back load does not become less than a predetermined threshold value.

3. A vehicle driving posture adjusting device comprising:
a seat cushion having a cushion length varying mechanism that is able to change a length of the seat cushion in a seat front-rear direction and a seat surface angle varying mechanism that is able to change a seat surface angle;
a cushion load detection device provided in the seat cushion and configured to detect a cushion load applied to the seat cushion by a seated occupant;
a back load detection device provided in a seat back and configured to detect a back load applied to the seat back by the seated occupant; and
a foot placement detection device configured to detect that a foot of the seated occupant is placed on an accelerator pedal, wherein
when adjusting a driving posture, the cushion length varying mechanism adjusts the length of the seat cushion in the seat front-rear direction and the seat surface angle varying mechanism adjusts the seat surface angle of the seat cushion such that the cushion load does not exceed a predetermined threshold value and the back load does not become less than a predetermined threshold value using information on detection of foot placement on the accelerator pedal from the foot placement detection device as a trigger.

4. The vehicle driving posture adjusting device according to claim 1, wherein:
among a cushion front end sensor that detects a cushion load acting on a front end surface of the seat cushion and a cushion upper surface sensor that detects a cushion load acting on a seat surface front portion of the seat cushion, the cushion load detection device includes at least the cushion front end sensor; and
the foot placement detection device includes any of a pedal operation amount sensor, a pressure sensor provided on an upper surface of the accelerator pedal, and a foot camera.

5. The vehicle driving posture adjusting device according to claim 1, wherein:
the cushion load detection device includes a cushion front-end upper portion sensor that detects a cushion load acting on a front-end upper portion of the seat cushion; and
the foot placement detection device includes any of a pedal operation amount sensor, a pressure sensor provided on an upper surface of the accelerator pedal, and a foot camera.
